(19) United States
(12) Patent Application Publication
(10) Pub. No.: US 2014/0176867 A1
(43) Pub. Date: Jun. 26, 2014

(54) EDGE TYPE BACKLIGHT MODULE AND LIQUID CRYSTAL DISPLAY FOR PREVENTING LIGHT LEAKAGE

(71) Applicant: Shenzhen China Star Optoelectronics Technology Co, Ltd., Shenzhen (CN)

(72) Inventor: Chong Huang, Shenzhen (CN)

(21) Appl. No.: 13/807,000

(22) PCT Filed: Nov. 17, 2012
(86) PCT No.: PCT/CN2012/084789

§ 371 Date: Dec. 26, 2012

(30) Foreign Application Priority Data
Nov. 14, 2012 (CN) 201210456303.5

(51) Int. Cl. F21V 8/00

(52) U.S. Cl. CPC G02B 6/0081
USPC 349/65; 362/606

(57) ABSTRACT

An edge type backlight module for preventing light leakage is disclosed. The backlight module includes an aluminum extrusion, an edge type light source, an optical film set, and a plastic frame. The an adhesive bar is arranged at least partly in a space between the aluminum extrusion and the plastic frame to fix the aluminum extrusion and the plastic frame and to fill a gap between the aluminum extrusion and the plastic frame. A liquid crystal display with the above backlight module is also disclosed. With the configuration, the aluminum extrusion and the plastic frame may be easily fixed, and the light leakage may be avoided.

This application claims priority to China Patent Application No. 201210456303.5 filed on Nov. 14, 2012 entitled, EDGE TYPE BACKLIGHT MODULE AND LIQUID CRYSTAL DISPLAY FOR PREVENTING LIGHT LEAKAGE, all of the disclosures of which are incorporated herein by reference in their entirety.

### BACKGROUND OF THE INVENTION

1. Field of the Invention

Embodiments of the present disclosure relate to thin film transistor liquid crystal display (TFT-LCD) technology, and more particularly to an edge type backlight module and a liquid display device.

2. Discussion of the Related Art

Most of typical TFT-LCDs adopt Light Emitting Diode (LED) as a light source as the LEDs have the attributes of high-efficiency and energy-saving.

Currently, the edge type backlight modules are popular as the thickness of the liquid crystal display is critical. FIG. 1 is a schematic view of one typical edge type backlight module. The backlight module includes a backplane 1, a light guiding plate 2, an optical film set 3, a liquid crystal panel 4, a reflective sheet 5, a plastic frame 6, an edge type light source 7 and a front frame 8. The plastic frame 6 is assembled with a bending wall 10 of the aluminum extrusion 1 by engaging a hook of the plastic frame 6 and a snap of the bending wall 10. Most of the backplanes are made of aluminum plate, and the light source 6 adheres to the bending wall 10 of the backplane via a thermal pad.

As the bending may affect the heat dissipation of the LEDs, the aluminum extrusion may replace the aluminum plate to overcome the issue. However, it is difficult to manufacture the snap on the aluminum extrusion, and thus the plastic frame cannot be fixed. In addition, the light leakage may exist. If the plastic frame is fixed by screws, the aluminum extrusion may deform as the thickness of the aluminum extrusion is small, i.e., 0.8 mm to 1.2 mm. And the deformation results in a bad flatness of the adhered light sources and the light leakage.

### SUMMARY

The object of the claimed invention is to provide an edge type backlight module and a liquid display device for preventing light leakage.

In one aspect, an edge type backlight module includes: an aluminum extrusion includes at least partly of a vertical plate; an edge type light source arranged on an internal sidewall of the vertical plate; a light guiding plate includes a light incident surface and a light emitting surface, and the light incident surface faces toward the edge type light source; an optical film set is arranged on the light guiding plate and faces toward the light emitting surface of the light guiding plate; a plastic frame arranged in a rim of the aluminum extrusion and covers the rim of the optical film set; and an adhesive bar is arranged at least partly in a space between the aluminum extrusion and the plastic frame to fix the aluminum extrusion and the plastic frame and to fill a gap between the aluminum extrusion and the plastic frame.

Wherein the aluminum extrusion further includes a bottom plate and a vertical plate extending from the bottom plate, the vertical plate is vertical to the bottom, and the plastic frame includes a side plate and a top plate extending from the side plate.

Wherein the adhesive bar is arranged at least partly in the space between an outer sidewall of the vertical plate and an internal wall of the side plate.

Wherein a plurality of adhesive bars is arranged between the outer sidewall of the vertical plate and the internal wall of the side plate, and the adhesive bars are spaced apart from each other.

Wherein the space between portions of the outer sidewall of the vertical plate and the internal wall of the side plate, and the space between a top of the vertical plate and the top plate of the plastic frame are arranged with the adhesive bar.

Wherein the adhesive bar is a double-sided adhesive tape.

Wherein the liquid crystal panel is arranged on the optical film set, the liquid crystal panel is assembled with the plastic frame by the front frame, and the reflective sheet is arranged below the light guiding plate.

Wherein the edge type light source is a LED light bar adhering to an internal wall of the vertical plate.

In another aspect, an edge type backlight module includes: an aluminum extrusion includes a bottom plate and a vertical plate extending from the bottom plate, and the vertical plate is vertical to the bottom plate; an edge type light source is arranged on an internal sidewall of the vertical plate; a light guiding plate includes a light incident surface and a light emitting surface, and the light incident surface faces toward the edge type light source; an optical film set is arranged on the light guiding plate and faces toward the light emitting surface of the light guiding plate; a plastic frame arranged in a rim of the aluminum extrusion, the plastic frame includes a side plate and a top plate extending from the side plate, and the plastic frame covers the rim of the optical film set; and a space between at least portions of an outer sidewall of the vertical plate and an internal wall of the side plate of the plastic frame, or/and a space between a top of the vertical plate and a top plate of the plastic frame are arranged with the adhesive bar to fix the aluminum extrusion and the plastic frame such that the gap between the aluminum extrusion and the plastic frame are filled.

Wherein a plurality of adhesive bars is arranged between the outer sidewall of the vertical plate and the internal wall of the side plate, and the adhesive bars are spaced apart from each other.

Wherein the adhesive bar is a double-sided adhesive tape.

Wherein the liquid crystal panel is arranged on the optical film set, the liquid crystal panel is assembled with the plastic frame by the front frame, and the reflective sheet is arranged below the light guiding plate.

Wherein the edge type light source is a LED light bar adhering to an internal wall of the vertical plate.

In another aspect, a liquid crystal display includes the edge type backlight module as claimed in any of claims 1 to 8.

### BRIEF DESCRIPTION OF THE DRAWINGS

FIG. 1 is a schematic view of a typical edge type backlight module.

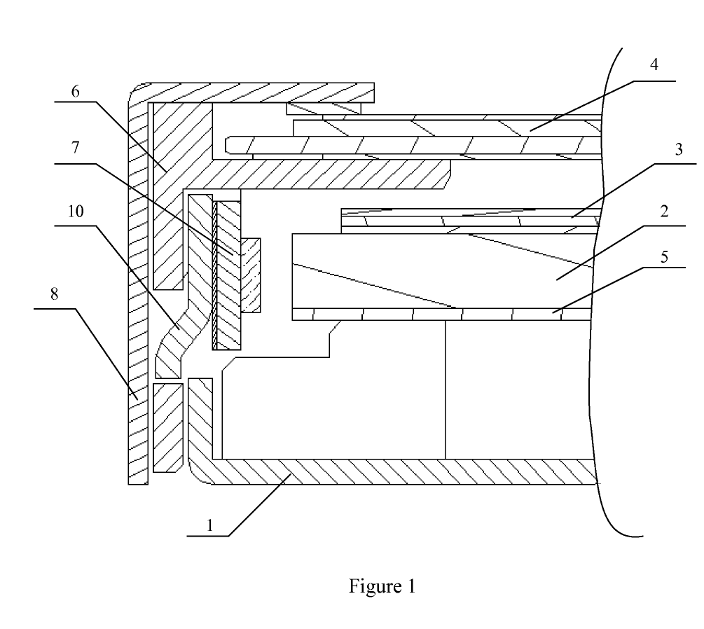

FIG. 2 is a schematic view of the edge type backlight module in accordance with a first embodiment.

FIG. 3 is a schematic view of the edge type backlight module in accordance with a second embodiment.

FIG. 4 is a schematic view of the edge type backlight module in accordance with a third embodiment.

FIG. 5 is a schematic view of the edge type backlight module in accordance with a fourth embodiment.

FIG. 6 is a schematic view of the edge type backlight module in accordance with a fifth embodiment.

### DETAILED DESCRIPTION OF THE EMBODIMENTS

Embodiments of the invention will now be described more fully hereinafter with reference to the accompanying drawings, in which embodiments of the invention are shown.

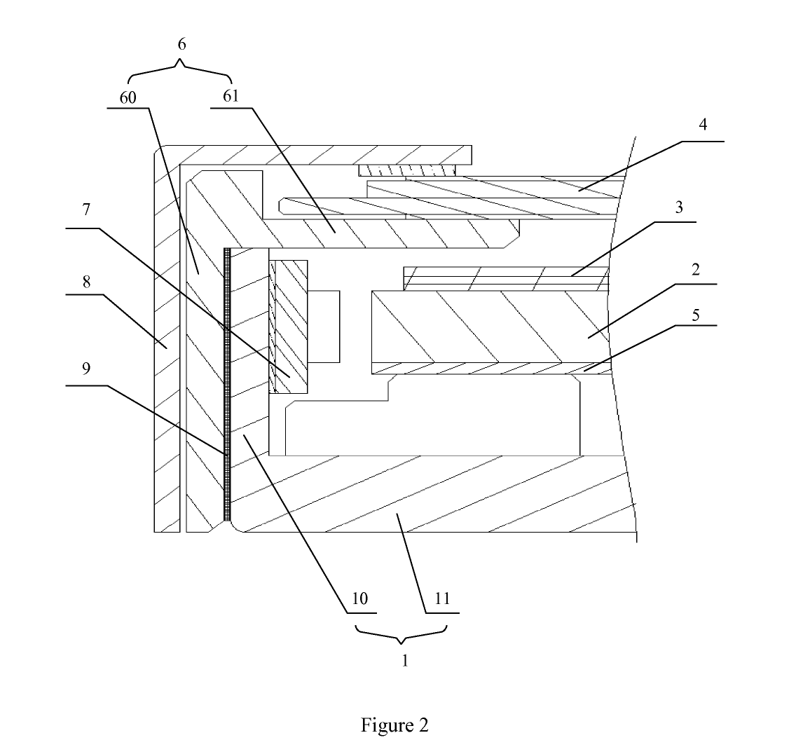

FIG. 2 is a schematic view of the edge type backlight module in accordance with a first embodiment. In the embodiment, the edge type backlight module includes an aluminum extrusion 1, an edge type light source 7, a light guiding plate 2, an optical film set 3, a liquid crystal panel 4, a reflective sheet 5, a plastic frame 6, and a front frame 8.

The aluminum extrusion 1 includes a bottom plate 11 and a vertical plate 10 extending from the bottom plate 11. The vertical plate 10 is vertical to the bottom plate 11.

The edge type light source 7 may be a LED light bar adhering to an internal sidewall of the vertical plate 10 by heat conductive glue.

The light guiding plate 2 has a light incident surface and a light emitting surface. The light incident surface faces toward the edge type light source 7. The optical film set 3 includes a plurality of optical films, such as a diffusion film or a prism film. In this way, lights from the light emitting surface are uniformly distributed after passing through the optical film set 3.

The optical film set 3 is arranged on the light guiding plate 2 and faces toward the light emitting surface of the light guiding plate 2.

The liquid crystal panel 4 is arranged on the optical film set 3. The reflective sheet 5 is arranged below the light guiding plate 2. The plastic frame 6 is arranged in a rim of the aluminum extrusion 1 and covers the rim of the optical film set 3. The plastic frame 6 includes a side plate 60 and a top plate 61 extending from the side plate 60. The top plate 61 is substantially parallel to the optical film set 3. The side plate 60 covers the rim of the optical film set 3.

The liquid crystal panel 4 is assembled with the plastic frame 6 by the front frame 8.

Furthermore, an adhesive bar 9 is arranged at least partly in the space between the aluminum extrusion 1 and the plastic frame 6 to fix the aluminum extrusion 1 and the plastic frame 6. In addition, the adhesive bar 9 also fills the gap between the aluminum extrusion 1 and the plastic frame 6.

As shown in FIG. 2, the adhesive bar 9 is arranged between an outer sidewall of the vertical plate 10 and the internal wall of the side plate 60 to fill the gap therebetween. In other embodiments, the adhesive bar 9 may be a double-sided adhesive tape.

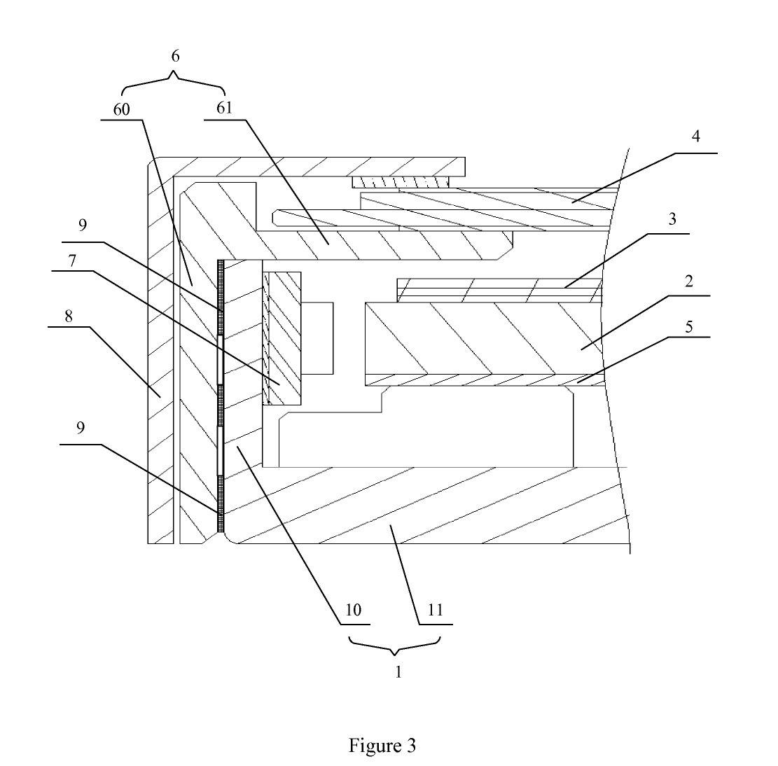

FIG. 3 is a schematic view of the edge type backlight module in accordance with a second embodiment. As shown in FIG. 3, a plurality of adhesive bars 9 are arranged between the outer sidewall of the vertical plate 10 and the internal wall of the side plate 60 so that the gap is filled to avoid the light leakage. The adhesive bars are spaced apart from each other.

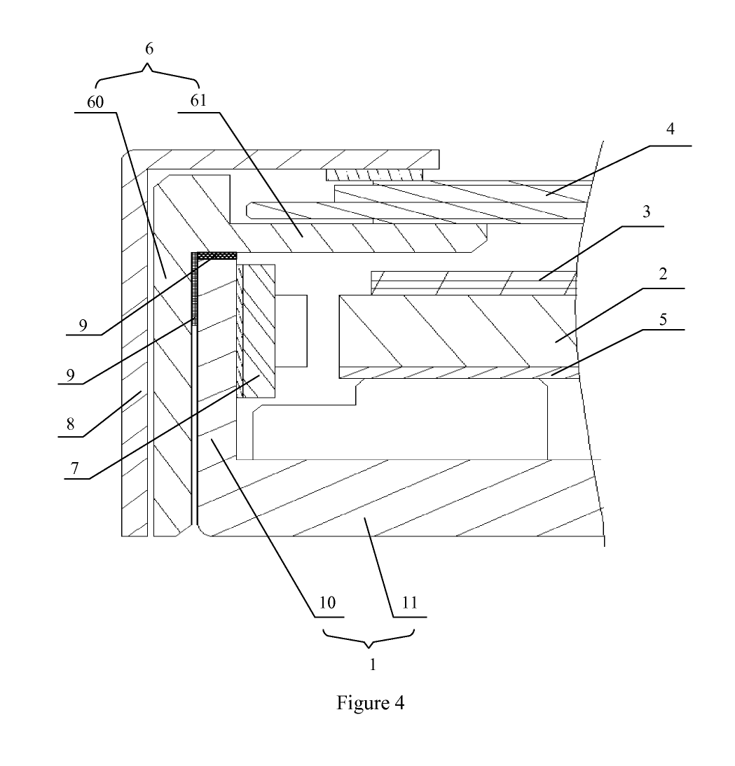

FIG. 4 is a schematic view of the edge type backlight module in accordance with a third embodiment. As shown in FIG. 4, the space between at least portions of the outer sidewall of the vertical plate 10 and the internal wall of the side plate 60, and the space between a top of the vertical plate 10 and the top plate 61 of the plastic frame 6 are arranged with the adhesive bar 9. The adhesive bar 9 fills the gap between the above locations to avoid the light leakage.

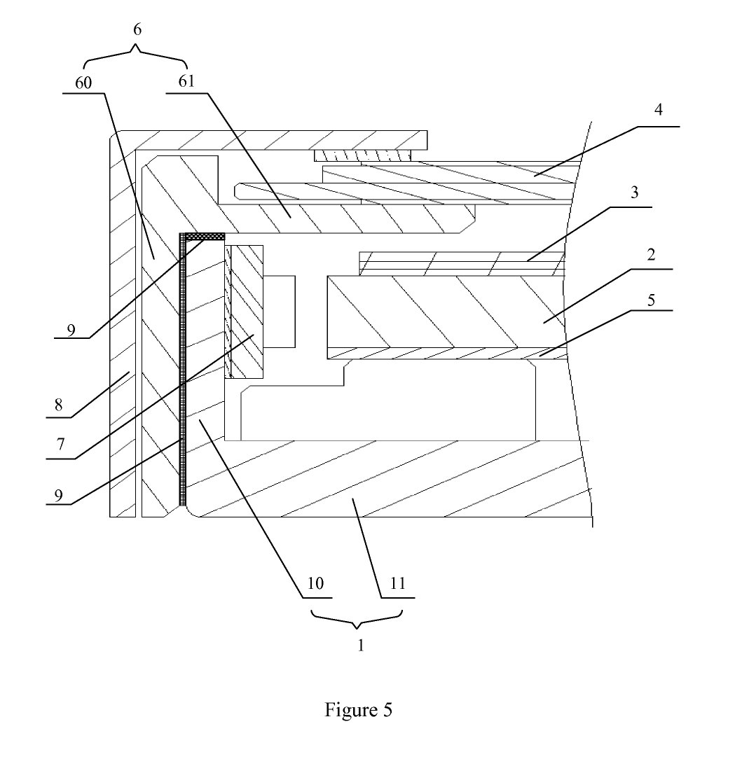

FIG. 5 is a schematic view of the edge type backlight module in accordance with a fourth embodiment. As shown in FIG. 5, the gap between the outer sidewalls of the vertical plate 10 and the internal wall of the side plate 60, and a top of the vertical plate 10 and the top plate 61 of the plastic frame 6 are filled with the adhesive bar 9 to avoid the light leakage.

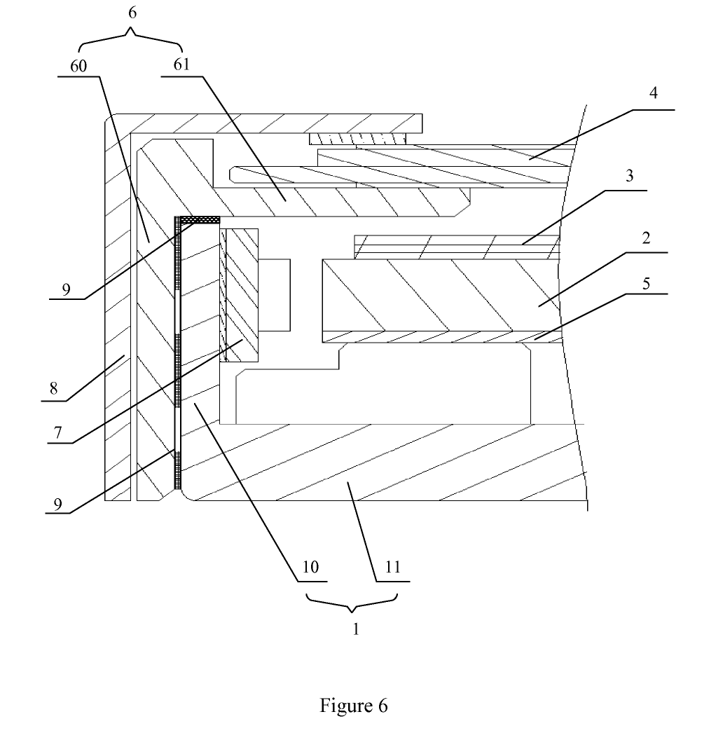

FIG. 6 is a schematic view of the edge type backlight module in accordance with a fifth embodiment. As shown in FIG. 6, the gaps between the outer sidewalls of the vertical plate 10 and the internal wall of the side plate 60, and the top of the vertical plate 10 and the top plate 61 of the plastic frame 6 are all filled with the adhesive bar 9 to avoid the light leakage.

In one embodiment, a liquid crystal display includes the edge type backlight module as shown in FIGS. 2-6.

In view of the above, the adhesive bar or double-sided adhesive tape is arranged between the aluminum extrusion and the plastic frame. Not only the aluminum extrusion and plastic frame are fixed, but also the gap between the aluminum extrusion and plastic frame are filled. As such, the light leakage is avoided.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An edge type backlight module, comprising:
an aluminum extrusion comprises at least partly of a vertical plate;
an edge type light source arranged on an internal sidewall of the vertical plate;
a light guiding plate comprises a light incident surface and a light emitting surface, and the light incident surface faces toward the edge type light source;
an optical film set is arranged on the light guiding plate and faces toward the light emitting surface of the light guiding plate;
a plastic frame arranged in a rim of the aluminum extrusion and covers the rim of the optical film set; and
an adhesive bar is arranged at least partly in a space between the aluminum extrusion and the plastic frame to fix the aluminum extrusion and the plastic frame and to fill a gap between the aluminum extrusion and the plastic frame.

2. The backlight module as claimed in claim 1, wherein the aluminum extrusion further comprises a bottom plate and a vertical plate extending from the bottom plate, the vertical plate is vertical to the bottom, and the plastic frame comprises a side plate and a top plate extending from the side plate.

3. The backlight module as claimed in claim 2, wherein the adhesive bar is arranged at least partly in the space between an outer sidewall of the vertical plate and an internal wall of the side plate.

4. The backlight module as claimed in claim 3, wherein a plurality of adhesive bars is arranged between the outer sidewall of the vertical plate and the internal wall of the side plate, and the adhesive bars are spaced apart from each other.

5. The backlight module as claimed in claim 2, wherein the space between portions of the outer sidewall of the vertical plate and the internal wall of the side plate, and the space between a top of the vertical plate and the top plate of the plastic frame are arranged with the adhesive bar.

6. The backlight module as claimed in claim 1, wherein the adhesive bar is a double-sided adhesive tape.

7. The backlight module as claimed in claim 6, wherein the liquid crystal panel is arranged on the optical film set, the liquid crystal panel is assembled with the plastic frame by the front frame, and the reflective sheet is arranged below the light guiding plate.

8. The backlight module as claimed in claim 6, wherein the edge type light source is a LED light bar adhering to an internal wall of the vertical plate.

9. An edge type backlight module, comprising:
an aluminum extrusion comprises a bottom plate and a vertical plate extending from the bottom plate, and the vertical plate is vertical to the bottom plate;
an edge type light source is arranged on an internal sidewall of the vertical plate;
a light guiding plate comprises a light incident surface and a light emitting surface, and the light incident surface faces toward the edge type light source;
an optical film set is arranged on the light guiding plate and faces toward the light emitting surface of the light guiding plate;
a plastic frame arranged in a rim of the aluminum extrusion, the plastic frame comprises a side plate and a top plate extending from the side plate, and the plastic frame covers the rim of the optical film set; and
a space between at least portions of an outer sidewall of the vertical plate and an internal wall of the side plate of the plastic frame, or/and a space between a top of the vertical plate and a top plate of the plastic frame are arranged with the adhesive bar to fix the aluminum extrusion and the plastic frame such that the gap between the aluminum extrusion and the plastic frame are filled.

10. The backlight module as claimed in claim 9, wherein a plurality of adhesive bars is arranged between the outer sidewall of the vertical plate and the internal wall of the side plate, and the adhesive bars are spaced apart from each other.

11. The backlight module as claimed in claim 9, wherein the adhesive bar is a double-sided adhesive tape.

12. The backlight module as claimed in claim 11, wherein the liquid crystal panel is arranged on the optical film set, the liquid crystal panel is assembled with the plastic frame by the front frame, and the reflective sheet is arranged below the light guiding plate.

13. The backlight module as claimed in claim 12, wherein the edge type light source is a LED light bar adhering to an internal wall of the vertical plate.

14. A liquid crystal display comprises the edge type backlight module as claimed in any of claims 1 to 8.
